(19) United States
(12) Patent Application Publication
(10) Pub. No.: US 2026/0204741 A1
(43) Pub. Date: Jul. 16, 2026

(54) ARRANGEMENT OF CELLS OF AN ENERGY STORAGE ELEMENT AND METHOD FOR ASSEMBLING THIS ARRANGEMENT

(71) Applicant: SAFRAN ELECTRICAL & POWER, Blagnac Cedex (FR)

(72) Inventors: Frédéric Pinard, Moissy-Cramayel (FR); Kevin Kappler, Moissy-Cramayel (FR); Sébastien Thomassier, Moissy-Cramayel (FR)

(73) Assignee: SAFRAN ELECTRICAL & POWER, Blagnac Cedex (FR)

(21) Appl. No.: 19/136,557

(22) PCT Filed: Nov. 27, 2023
(86) PCT No.: PCT/FR2023/051854

§ 371 Date: Jun. 6, 2025

(30) Foreign Application Priority Data
Dec. 7, 2022 (FR) FR2212877

(51) Int. Cl. H01M 50/517; H01M 50/211; H01M 50/244; H01M 50/503; H01M 50/557

(52) U.S. Cl. CPC H01M 50/517; H01M 50/211; H01M 50/244; H01M 50/503; H01M 50/557

(57) ABSTRACT

Assembly of cells of an energy storage element comprising at least a first and a second adjacent cell each comprising two electrical connection tabs, respectively of positive polarity and negative polarity.
Each of the tabs of the first cell comprises a folded portion extending from said first cell to the second cell and each of the tabs of the second cell comprises a folded portion extending from said second cell to the first cell.
The assembly comprises a consecutive stack comprising a support, a first conductive bar, the folded portion of the connection tab of the first cell, a second conductive bar, the folded portion of the connection tab of the second cell, and a third conductive bar, the assembly comprising means for the reversible fastening of this stack which are configured to apply a clamping force to the stack.

### TECHNICAL FIELD OF THE INVENTION

The present invention relates to the field of electrical energy storage devices such as batteries.

More specifically, the invention relates to the electrical connection of cells, in particular so-called pouch cells, within a battery to form an assembly of cells.

### PRIOR ART

Electrical energy storage devices comprise electrochemical elements or so-called pouch cells.

FIG. 1 shows the assembly 1 of cells 1a to 1h; here there are eight. Each of the cells comprises two electrical connection tabs 2a, 3a to 2h, 3h, respectively of positive polarity and negative polarity.

In order to connect the cells together, it is known to use laser welding to connect the tabs of the cells. However, laser welding is not suitable for all metallic materials, especially when combining a copper part with an aluminium part. Moreover, this type of fastening does not allow the cells of the same sub-assembly to be separated without damaging it.

Another solution for connecting the cells involves assembling the cells by stamping or clinching by adding a U-shaped cross-section part. However, such a solution considerably increases the footprint of the assembly and requires sufficient clearance for a tool used to stamp the part. Furthermore, this type of fastening does not allow the cells of the same sub-assembly to be separated without damaging it.

It is also known to use ultrasonic welding to connect the cells together. Although such a solution provides mechanical strength, it requires sufficient clearance for a tool to be used for welding. Furthermore, this type of fastening does not allow the cells of the same sub-assembly to be separated without damaging it and can generate internal mechanical stresses on the cells.

There is a need to optimise the electrical connection of the cells within a battery.

### DISCLOSURE OF THE INVENTION

The object of the present invention is therefore to overcome the aforementioned disadvantages.

The object of the invention is to improve the electrical connection of the cells in a battery cell assembly to enable the individual cells to be dismantled, while minimising the impact on the total mass of the cell assembly and ensuring the electrical performance of the cells.

The object of the invention is an assembly of cells of an energy storage element, such as a battery, comprising at least a first and a second adjacent cell each comprising two electrical connection tabs, respectively of positive polarity and negative polarity.

Each of the tabs of the first cell comprises a folded portion extending from said first cell to the second cell and each of the tabs of the second cell comprises a folded portion extending from said second cell to the first cell.

The assembly comprises a consecutive stack comprising at least one support, a first conductive bar, the folded portion of one of the connection tabs of the first cell, a second conductive bar, the folded portion of one of the connection tabs of the second cell, and a third conductive bar.

The assembly of cells comprises means for the reversible fastening of this stack which are configured to apply a clamping force to the stack.

Thus, the electrical connection of the cells in a battery cell assembly is efficient and it is possible to dismantle individual cells, for example during a maintenance operation, without affecting the mechanical integrity of the other cells.

For example, it could be provided that the assembly of cells comprises a number greater than or equal to three cells arranged in parallel or in series.

Advantageously, each electrical connection tab comprises a first part extending from an end of the main portion of the corresponding cell and a folded portion extending from an end of the first part perpendicular to said first part.

Thus, the folded portion extends along the longitudinal axis perpendicular to the extension axis of the cell towards the adjacent cell.

In other words, the folded portion of the electrical connection tab of the first cell extends along the longitudinal axis to the second adjacent cell and the folded portion of the electrical connection tab of the second cell extends along the longitudinal axis to the first adjacent cell.

The conductive tabs are, for example, around 0.15 mm thick.

The conductive tabs are, for example, made of metallic material, such as copper, aluminium or nickel. The conductive tabs can thus be folded.

Advantageously, the electrically insulating support is arranged between the two adjacent cells and the first conductive bar is arranged on the support.

The support comprises, for example, a width less than the longitudinal distance between two adjacent cells.

In other words, a longitudinal gap remains between the support and each of the cells.

The first, second and third conductive bars are preferably made of the same material, such as for example a metallic material, such as aluminium.

Thus, the first, second and third conductive bars have the same electrical resistivity.

Advantageously, the second conductive bar has a thickness greater than the thickness of each of the first and third conductive bars.

Indeed, the current supplied by the first cell is carried by the first and second conductive bars and the current supplied by the second cell is carried by the second and third conductive bars. Thus, the second conductive bar carries a current coming from both the first cell and the second cell. For example, the thickness of the second conductive bar is equal to twice the thickness of each of the first and third conductive bars.

Thus, the temperature of the conductive bars in contact with the cells is homogenised, which makes it possible to homogenise the temperature of the cells.

Advantageously, each of the first, second and third bars comprises a hole cooperating with the reversible fastening means, said holes being coaxial to allow the passage of said fastening means.

For example, the reversible fastening means comprise at least one screwing means cooperating with the support.

According to one embodiment, the screwing means is a screw cooperating with a tapped hole made in the support.

Alternatively, it could be provided that the support comprises a threaded extension, for example a stud, extending into the holes of the conductive bars and cooperating with a nut.

Fastening the consecutive stack of the support, the first conductive bar, the folded portion of the connection tab of the first cell, the second conductive bar, the folded portion of the connection tab of the second cell, and the third conductive bar is carried out by screwing the screws into the corresponding tapped hole made in the support, or by tightening the nut cooperating with the stud.

The pressure applied when tightening the screws or the nut allows the necessary current to flow between the conductive bars and the tabs by deformation of said conductive bars on the tabs.

According to one embodiment, the reversible fastening means comprise at least two screwing means each cooperating with the support.

According to one embodiment, the assembly further comprises a spring means, for example in the form of a spring leaf, mounted between the two screwing means and the third conductive bar.

Thus, the spring leaf comprises a first portion attached to a first screwing means integral with the bearing portions of the conductive bars, a second portion attached to a second screwing means integral with the connecting portions of the conductive bars and a central portion connecting the first and second portion. The central portion bears on the third conductive bar.

According to one embodiment, the folded portions of the tabs of the cells each comprise a through-hole cooperating with the screwing means.

Said through-hole is coaxial with the holes drilled on the first, second and third bars and with the tapped hole or threaded stud of the support.

For example, the first, second, and third bars have a shape configured to connect one of the tabs of a cell with one of the tabs of an adjacent cell.

For example, the assembly of cells comprises a number of cells equal to eight.

For example, the first, second, and third bars have an E-shape comprising a plurality of transverse bearing portions, each bearing on the folded portion of the tab of the second cell and a longitudinal connecting portion connecting said bearing portions.

Preferably, if there is an even number of cells, the number of bearing portions is equal to half the number of cells. If there is an odd number of cells, the number of bearing portions is equal to half the number of cells plus a bearing portion.

Each of the bearing portions of the third conductive bar may comprise a through hole cooperating with a screw.

Similarly, each of the bearing portions of the first and second conductive bars may comprise a through hole, of which only two holes cooperate with the screw. The holes made on the first, second and third bars are coaxial.

For example, the connecting portion of the third bar further comprises a second series of holes opening into a tapped hole made in the support.

According to a second aspect, the invention relates to a method for assembling an assembly of cells of an energy storage element, such as a battery, comprising at least a first and a second adjacent cell each comprising two electrical connection tabs, respectively of positive polarity and negative polarity.

Depending on the assembly method:
a first conductive bar is positioned on a support;
one of the tabs of the first cell is folded onto the first conductive bar until a folded portion of said tab is in contact with said first conductive bar;
a second conductive bar is positioned on the folded portion of said tab of the first cell;
one of the tabs of the second cell is folded onto the second conductive bar until a folded portion of said tab is in contact with said second conductive bar;
a third conductive bar is positioned on the folded portion of said tab of the second cell; and
the consecutive stack of the support, the first conductive bar, the folded portion of the connection tab of the first cell, the second conductive bar, the folded portion of the connection tab of the second cell, and the third conductive bar is fastened by reversible fastening means.

Said reversible fastening means are configured to apply a clamping force to said stack.

At the end of the stacking step, a consecutive stack is thus obtained of the support, the first conductive bar, the folded portion of the connection tab of the first cell, the second conductive bar, the folded portion of the connection tab of the second cell, and the third conductive bar.

### BRIEF DESCRIPTION OF THE DRAWINGS

Further aims, features and advantages of the invention will become apparent from reading the following description, provided solely by way of non-limiting example, with reference to the accompanying drawings in which:

FIG. 1 is a perspective view of a battery cell assembly according to the prior art;

FIG. 2 is a sectional view of an assembly of cells according to one embodiment of the invention;

FIG. 3 is a partial perspective view of a step of assembling the assembly of cells according to FIG. 2;

FIG. 4 is a perspective view of the assembly of cells according to FIG. 2;

FIG. 5 is a sectional view of an assembly of cells according to another embodiment of the invention;

FIG. 6 is a sectional view of an assembly of cells according to another embodiment of the invention; and

FIG. 7 shows a flowchart of a method for assembling the assembly of cells shown in FIG. 2.

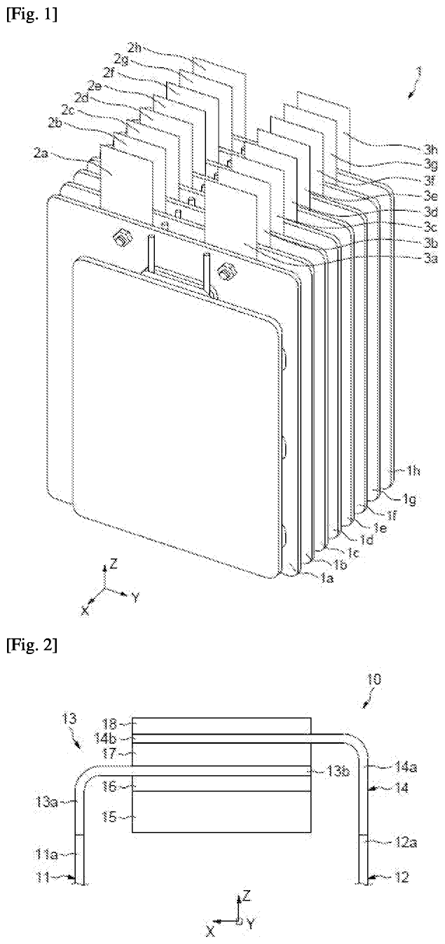

### DETAILED DISCLOSURE OF AT LEAST ONE EMBODIMENT

In the remainder of the description, an orthonormal coordinate system X, Y, Z is defined in which:
the X axis represents a longitudinal axis defining the stacking axis of the cells of the assembly of cells;
the Y axis represents a transverse axis, extending across the width of the cells; and
the axis Z represents a vertical axis, perpendicular to the longitudinal axis X and to the transverse axis Y.

With reference to the example shown in FIGS. 2 to 4, an assembly 10 of cells of a battery are arranged in parallel along the longitudinal axis X.

As shown in FIG. 2, the assembly 10 comprises, in a non-limiting manner, two cells 11, 12. Alternatively, it could be provided that the assembly 10 comprises a number greater than or equal to three cells arranged in parallel.

Each cell 11, 12 comprises a main portion 11a, 12a extending along the vertical axis and two electrical connection tabs 13, 14, respectively of positive polarity and negative polarity, only one of which is shown in FIG. 2.

Each electrical connection tab 13, 14 comprises a first part 13a, 14a extending from an end of the main portion 11a, 12a of the corresponding cell 11, 12 and a folded portion 13b, 14b extending from an end of the first part 13a, 14a perpendicular to said first part 13a, 14a. Thus, the folded portion 13b, 14b of each connection tab extends along the longitudinal axis X towards the adjacent cell 11, 12.

In other words, the folded portion 13b of each electrical connection tab 13 of the first cell 11 extends along the longitudinal axis X to the second adjacent cell 12 and the folded portion 14b of each electrical connection tab 14 of the second cell 12 extends along the longitudinal axis X to the first adjacent cell 11.

As shown in FIG. 2, the assembly 10 further comprises an electrically insulating support 15 arranged between two adjacent cells 11, 12. The longitudinal dimension or width along the longitudinal axis X of the support 15 is, here, less than the longitudinal distance between two adjacent cells 11, 12. In other words, a longitudinal gap remains between the support 15 and each of the cells 11, 12.

As shown in FIG. 2, the assembly 10 further comprises a first conductive bar 16 arranged on the support 15 and on which the folded portion 13b of the connection tab 13 of the first cell 11 bears.

The assembly 10 further comprises a second conductive bar 17 arranged on the folded portion 13b of the connection tab 13 of the first cell 11 and on which the folded portion 14b of the connection tab 14 of the second cell 12 bears, and a third conductive bar 18 arranged on the folded portion 14b of the connection tab 14 of the second cell 12.

Thus, the assembly 10 successively comprises along the vertical axis Z, the support 15, the first conductive bar 16, the folded portion 13b of the connection tab 13 of the first cell 11, the second conductive bar 17, the folded portion 14b of the connection tab 14 of the second cell 12, and the third conductive bar 18.

The current supplied by the first cell 11 is carried by the first and second conductive bars 16, 17 and the current supplied by the second cell 12 is carried by the second and third conductive bars 17, 18.

The first, second and third conductive bars 16, 17, 18 are preferably made of the same material, such as for example a metallic material, such as aluminium. Thus, the first, second and third conductive bars 16, 17, 18 have the same electrical resistivity.

The second conductive bar 17 carries a current coming from both the first cell 11 and the second cell 12. The second conductive bar 17 preferably has a thickness greater than the thickness of each of the first and third conductive bars 16, 18. For example, the thickness of the second conductive bar 17 is equal to twice the thickness of each of the first and third conductive bars 16, 18.

Thus, the temperature of the conductive bars 16, 17, 18 in contact with the cells 11, 12 is homogenised, which makes it possible to homogenise the temperature of the cells 11, 12.

The first, second, and third bars 16, 17, 18 have a shape configured to connect one of the tabs of a cell with one of the tabs of an adjacent cell.

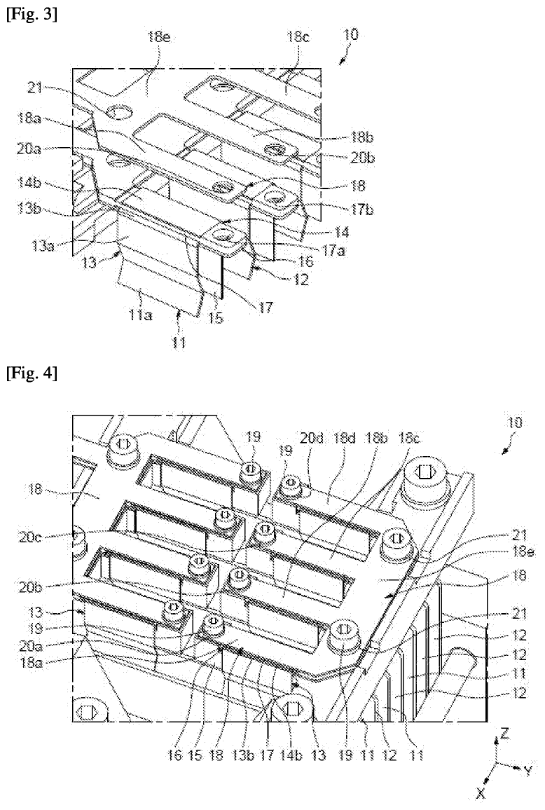

As can be seen in FIGS. 3 and 4 which show an exemplary assembly 10 comprising a number of cells equal to eight.

As shown in FIG. 3 and in a no way limiting manner, the first, second and third bars 16, 17, 18 have an X-shape, equivalent to the juxtaposition of an E-shape with an inverted E-shape.

The shape will be described with reference to the third bar 18, it being understood that the first and second bars 16, 17 have an identical shape to the shape of the third bar 18.

The third conductive bar 18 comprises four transverse bearing portions 18a, 18b, 18c, 18d, each bearing on the folded portion 14b of the tab 14 of the second cell 12 and a longitudinal connecting portion 18a connecting said bearing portions 18a, 18b, 18c, 18d.

Alternatively, a different number of bearing portions could be provided. The number of bearing portions is equal to half the number of cells.

Each of the bearing portions 18a, 18b, 18c, 18d of the third conductive bar 18 comprises a through hole 20a, 20b, 20c, 20d cooperating with a screw 19, forming a reversible fastening means.

Similarly, each of the bearing portions of the first and second conductive bars 16, 17 comprises a through hole, of which only two holes 17a, 17b are shown in FIG. 3, cooperating with the screw 19. The holes made on the first, second and third bars 16, 17, 18 are coaxial.

The connecting portion 18a of the third bar 18 further comprises a second series of holes 21 opening into a tapped hole (not shown in the figures) made in the support 15.

Alternatively, it could be provided that the support 15 comprises a threaded extension, for example a stud, extending into the holes of the conductive bars 16, 17, 18 and cooperating with a nut.

Fastening the consecutive stack of the support 15, the first conductive bar 16, the folded portion 13b of the connection tab 13 of the first cell 11, the second conductive bar 17, the folded portion 14b of the connection tab 14 of the second cell 12, and the third conductive bar 18 is carried out by screwing the screws 19 into the corresponding tapped hole made in the support 15.

The pressure applied when tightening the screws 19 allows the necessary current to flow between the conductive bars 16, 17, 18 and the tabs 13, 14 by deformation of said conductive bars 16, 17, 18 on the tabs 13, 14.

Thus, if one cell of the assembly 10 of cells is being replaced, it suffices to remove the third conductive bar 18 then the second conductive bar 17 when the first cell 11 is being replaced. The folded portions 13b, 14b of the tabs 13, 14 of the cell to be replaced are unfolded.

The ability to dismantle each cell individually reduces maintenance costs.

The tongues are thin, for example 0.15 mm, which generates an electrical stress. This makes it easier to fold and unfold the folded portions of the tabs.

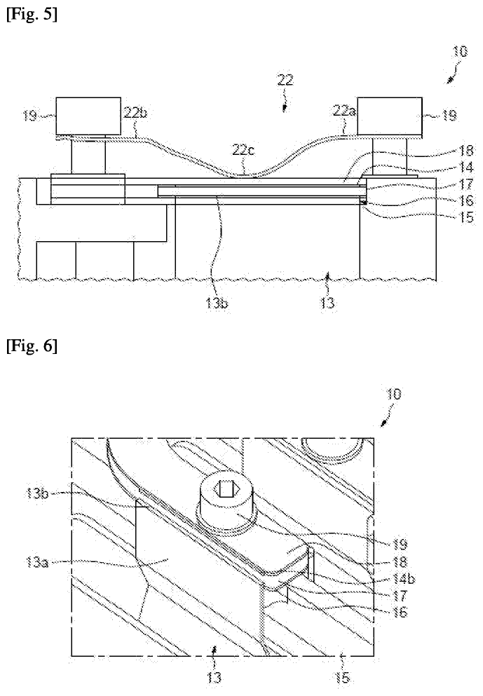

FIG. 5 shows another embodiment, wherein the same elements bear the same reference numerals and which differs from the embodiment shown in FIGS. 2 to 4 only in that the assembly 10 comprises a spring means 22, in the form of a leaf spring.

The spring leaf 22 is mounted between two screwing means 19 (screw or nut) and the third conductive bar 18.

Thus, the spring leaf 22 comprises a first portion 22a attached to a first screwing means 19 integral with the bearing portions of the conductive bars 16, 17, 18, a second portion 22b attached to a second screwing means 19 integral with the connecting portions of the conductive bars 16, 17, 18 and a central portion 22c connecting the first and second portion 22a, 22b. The central portion 22c bears on the third conductive bar 18.

FIG. 6 shows another embodiment, wherein the same elements bear the same reference numerals and which differs from the embodiment shown in FIGS. 2 to 4 only in that the folded portions 13b, 14b of the tabs 13, 14 of the cells 11, 12 of the assembly 10 each comprise a through-hole (not shown) cooperating with the screwing means 19. Said through-hole is coaxial with the holes drilled on the first, second and third bars 16, 17, 18 and with the tapped hole or threaded stud of the support 15.

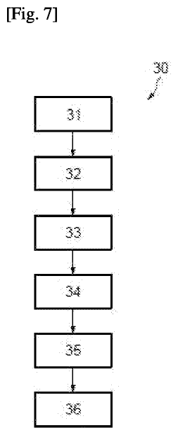

FIG. 7 shows a method 30 for assembling the assembly 10 of cells shown in FIG. 2 in which, in step 31, the first conductive bar 16 is positioned on the support 15, then, in step 32, the tab 13 of the first cell 11 is folded onto the first conductive bar 16 until the folded portion 13b is in contact with said first conductive bar 16.

Then, in step 33, the second conductive bar 17 is positioned on the folded portion 13b of the tab 13 of the first cell 11 and, in step 34, the tab 14 of the second cell 12, adjacent to the first cell 11, is folded onto the second conductive bar 17 until the folded portion 14b bears on said second conductive bar 17.

Then, in step 35, the third conductive bar 18 is positioned on the folded portion 14b of the tab 14 of the second cell 12.

At the end of step 35, a consecutive stack is obtained of the support 15, the first conductive bar 16, the folded portion 13b of the connection tab 13 of the first cell 11, the second conductive bar 17, the folded portion 14b of the connection tab 14 of the second cell 12, and the third conductive bar 18.

Then, in step 36, said stack is fastened by means of reversible fastening means, such as the screwing means 19 configured to apply a clamping force to said stack.

The connection of the cells is described here with reference to a connection of the cells in parallel with the connection of the negative electrodes on the one hand and the positive electrodes on the other hand. Alternatively, such a connection could be provided to connect cells in series with the connection of the negative electrodes with the positive electrodes of an adjacent cell.

Thanks to the invention, it is easy to replace the cells of an assembly of cells individually without damaging the rest of the assembly.

1. Assembly of cells of an energy storage element comprising at least a first and a second adjacent cell each comprising two electrical connection tabs, respectively of positive polarity and negative polarity, wherein each of the tabs of the first cell comprises a folded portion extending from said first cell to the second cell and each of the tabs of the second cell comprises a folded portion extending from the second cell to the first cell, and wherein the assembly comprises a consecutive stack comprising a support, a first conductive bar, the folded portion of one of the connection tabs of the first cell, a second conductive bar, the folded portion of one of the connection tabs of the second cell, and a third conductive bar, the assembly comprising means for the reversible fastening of said stack configured to apply a clamping force to said stack.

2. Assembly according to claim 1, wherein the electrically insulating support is arranged between the two adjacent cells and wherein the first conductive bar is arranged on the support.

3. Assembly according to claim 1, wherein the support comprises a width less than the longitudinal distance between two adjacent cells.

4. Assembly according to claim 1, wherein the first, second, and third conductive bars are made of the same material.

5. Assembly according to claim 1, wherein the second conductive bar has a thickness greater than the thickness of each of the first and third conductive bars.

6. Assembly according to claim 1, wherein each of the first, second, and third bars comprises a hole cooperating with the fastening means, said holes being coaxial.

7. Assembly according to claim 1. wherein the reversible fastening means comprise at least one screwing means cooperating with the support.

8. Assembly according to claim 7, wherein the reversible fastening means comprise at least two screwing means each cooperating with the support.

9. Assembly according to claim 8, comprising a spring means mounted between the two screwing means and the third conductive bar.

10. Assembly according to claim 1, wherein the folded portions of the tabs of the cells each comprise a through-hole cooperating with the screwing means.

11. Method for assembling an assembly of cells of an energy storage element comprising at least a first and a second adjacent cell each comprising two electrical connection tabs, respectively of positive polarity and negative polarity, wherein:
a first conductive bar is positioned on a support;
one of the tabs of the first cell is folded onto the first conductive bar until a folded portion of said tab is in contact with said first conductive bar;
a second conductive bar is positioned on the folded portion of said tab of the first cell;
one of the tabs of the second cell is folded onto the second conductive bar until a folded portion of said tab is in contact with said second conductive bar;
a third conductive bar is positioned on the folded portion of said tab of the second cell; and
the consecutive stack of the support, the first conductive bar, the folded portion of the connection tab of the first cell, the second conductive bar, the folded portion of the connection tab of the second cell, and the third conductive bar is fastened by reversible fastening means, said reversible fastening means being configured to apply a clamping force to said stack.
